(19) United States
(12) Patent Application Publication
(10) Pub. No.: US 2013/0242107 A1
(43) Pub. Date: Sep. 19, 2013

(54) Cloud Technology Surveillance System

(71) Applicant: Jingle Huang, Las Vegas, NV (US)

(72) Inventor: Jingle Huang, Las Vegas, NV (US)

(21) Appl. No.: 13/424,227

(22) Filed: Mar. 19, 2012

(51) Int. Cl. H04N 7/18

(52) U.S. Cl. 348/159; 348/E07.085

(57) ABSTRACT

A cloud technology surveillance(CTS) is provided. The CTS features low expense, high security, no configuration and separated owners. The CTS includes a surveillance server and a large number of IP cameras. Cameras send the images(videos or pictures) to cloud storage. The surveillance server locates in the internet, receives the images from cameras and responses viewers' operation. A surveillance system has at least twenty IP cameras including a first location first camera, a first location second camera, a first location second IP camera, a second location IP first camera, a second location IP second camera, and a second location IP third camera. A surveillance server is located in the Internet cloud and stores the images from at least twenty IP cameras and provides Internet access for remote viewers.

### DISCUSSION OF RELATED ART

Surveillance systems have been used widely in the offices, banks, stores, restaurants, and other locations but currently are not a household appliance because their high expense and complexity. Currently the internet is ubiquitous, widespread and using the internet for monitoring surveillance systems has become a common solution. Unfortunately, the internet is a digital network and most of the surveillance systems are analog signals, so most surveillance is not fully compatible with the internet. Another significant drawback of traditional surveillance is the security of the video recorder. The video recorder has traditionally been located in the same building as the cameras. This allows the video recorder to be and destroyed or tampered with.

### SUMMARY OF THE INVENTION

A cloud technology surveillance(CTS) is provided. The CTS features low expense, high security, no configuration and separated owners. A number of remote viewers can access the surveillance server. A first remote viewer, a second remote viewer, and up to a final remote viewer can access the surveillance server via the Internet cloud.

The CTS includes a surveillance server and a large number of IP cameras. Cameras send the images(videos or pictures) to cloud storage. The surveillance server locates on the internet, receives the images and audio from cameras and responds to viewers' operation queries. One embodiment the present invention includes an internet cloud technology surveillance system with a large number of IP cameras. This surveillance system has a cloud storage to store the images from IP cameras and a web server to provide the functions of authentication, searching, playback of images for viewers and an organizer for images. To lower the expense of the installations, all cameras share a common cloud storage server where the components of the surveillance system can be owned by different owner end users. Also, the cloud technology raises the security level of this surveillance system.

A surveillance system has at least twenty IP cameras including a first location first camera, a first location second camera, a first location second IP camera, a second location IP first camera, a second location IP second camera, and a second location IP third camera. A surveillance server is located in the Internet cloud and stores the images from at least twenty IP cameras and provides Internet access for remote viewers.

The surveillance system optionally includes a feature that the cloud storage receives the images from cameras. The cloud storage owns at least one domain name used by remote IP cameras. The web server owns at least one domain name used by remote viewers. The web server provides functions of authentication, searching and playback for viewers. The organizer retrieves the images from cloud storage, organizes and stores images to web server's storage.

Cloud technology surveillance is abbreviated as CTS. Internet protocol is abbreviated as IP. Ownership does not necessarily refer to legal title, but relates more to possession and technical access.

### BRIEF DESCRIPTION OF THE DRAWINGS

FIG. 1 is a system diagram showing the hardware components used to construct a preferred embodiment of the invention.

FIG. 2 is a diagram showing the hardware components and connections between camera and surveillance server.

FIG. 3 is a diagram showing the logical components of the surveillance server.

FIG. 4 is a diagram showing the logical components of the web server.

The following call a list of elements is a useful guide in referencing the elements of the drawings.
100 First IP Camera
101 Second IP Camera
102 Third IP Camera
103 Final IP Camera
104 Surveillance Server
105 Internet Cloud
106 First Remote Viewer
107 Second Remote Viewer
108 Final Remote Viewer
200 First Location First Camera
201 First Location Second Camera
202 First Location CTS Router
203 Surveillance Server
204 Internet Connection
205 First Location
206 Second Location First Camera
207 Second Location Second Camera
208 Second Location Third Camera
209 Second Location CTS Router
210 Internet Connection
211 Second Location
300 IP Cameras
302 Internet Connections
303 Viewers
304 Surveillance Server
305 Cloud Storage
306 Image Organizer
307 Web Server
400 Web Server
401 Image Storage
402 Authentication
403 http(s) Daemon

### DETAILED DESCRIPTION OF THE PREFERRED EMBODIMENT

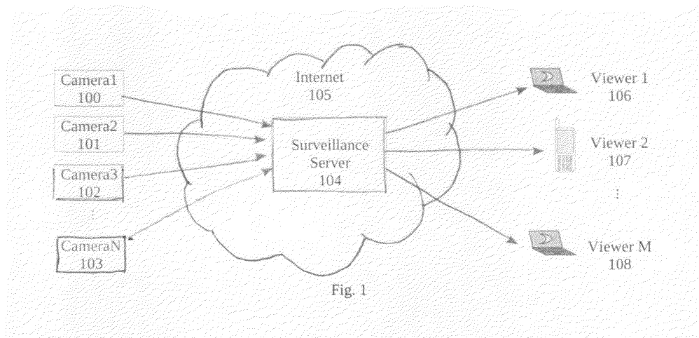

This invention provides a structure and method of security surveillance over the Internet. Images from IP cameras can be stored and viewed by web browsers. FIG. 1 shows the system structure.

This system includes IP cameras 100, 101, 102, 103 and a surveillance server 104. A large number of IP cameras can be connected to the surveillance server via the Internet including a first IP camera 100, a second IP camera 101, a third IP camera 102, all the way to a final IP camera 103. There can be for example 100 IP cameras.

The surveillance server 104 is located in the Internet cloud 105. A number of remote viewers can access the surveillance server 104. A first remote viewer 106, a second remote viewer 107, and up to a final remote viewer 108 can access the surveillance server 104 via the Internet cloud 105. Remote viewers 106, 107, 108 search and view the images stored on the server by PCs, mobile phones and other Internet terminals through their Internet connections. Remote viewers can also be a large number beginning from a first remote viewer 106, a second remote viewer 107, up to a final remote viewer 108. There can be a large number of viewers connected to the surveillance server 104 such as 100 viewers. FIG. 1 shows a first user 106 accessing the surveillance server by a laptop terminal. A second user is accessing the surveillance server using a mobile device such as cell phone. A final user is accessing the surveillance server using a mobile device such as a personal computer.

In this system, the quantity of connected cameras is infinite in theory. In reality, it is limited by the image size, network bandwidth, storage volume and server's computing speed. Currently, the quantity can be large, at least one hundred and preferably more than twenty. The cameras used are preferably digital network cameras, also called IP cameras. The digital network cameras can be wired or wireless. The surveillance server may be only one computing machine, or may be grouped by two or more computing machines. The surveillance server has at least two domain names, one used by cameras, and the other used by viewers.

Cameras and viewers don't need to know the physical location of the surveillance server, because they access the surveillance server via the domain names of the server. Lack of a defined physical location protects the camera image data and makes them harder to destroy. The surveillance server's security level is thus much higher than a traditional surveillance video recorder.

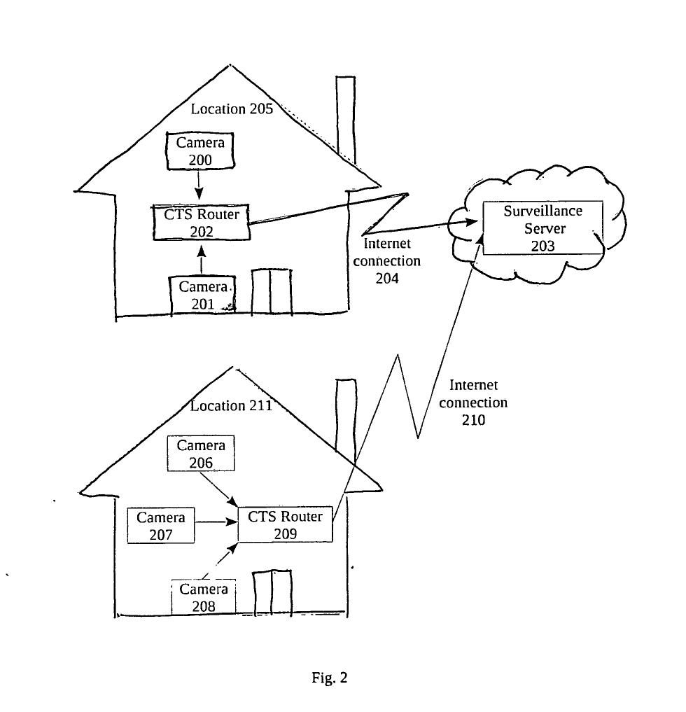

FIG. 2 shows the hardware parts and connections between the camera and surveillance server. At a first location 205, the first location may have a first location first camera 200 and a first location second camera 201. First location cameras 200, 201 connect to first location CTS router 202. First location CTS router 202 connects to the surveillance server 203 through Internet connection 204. A second location may have multiple cameras connected to the surveillance server 203. The second location may have a second location first camera 206, a second location second camera 207, and a second location third camera 208. The second location cameras 206, 207, 208 connect to second location CTS router 209. Second location CTS router 209 connects to the surveillance server 203 through the second location Internet connection 210.

As shown in FIG. 2, IP cameras which connect to the same surveillance server can be installed in different locations. All cameras use a domain name of the server to send their images. The components in one system can be owned by different people or organizations. For example, person A owns the first location first IP camera 200, first location second IP camera 201 and first location CTS router 202, while school B owns second location IP first camera 206, second location IP second camera 207, second location IP third camera 208 and second location CTS router 209, while security company C owns the surveillance server 203 located at a secure location. This configuration is different from a traditional surveillance configuration.

Because the camera owners don't need to pay for the surveillance server which can be the most expensive part, they can own the security monitoring function at a low price. All cameras and CTS routers can be set completely before they are sold. So, the buyers don't need to config them. When the cameras and routers are connected correctly and powered on, they will work automatically.

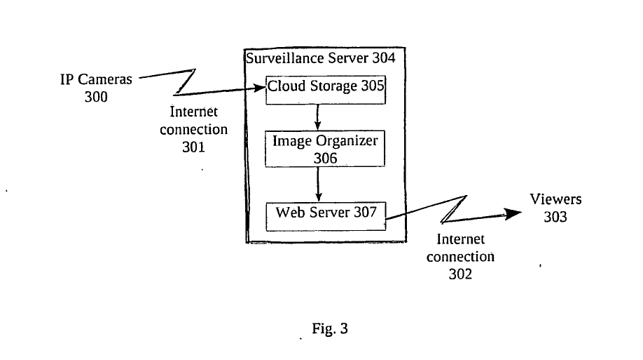

FIG. 3 depicts the logical configuration of the surveillance server. The surveillance server 304 is combined from three parts: the cloud storage 305, the image organizer 306 and the web server 307. The cloud storage 305 receives the images from the IP cameras 300. The cloud storage 305 has a domain name that is used by the cameras. The IP cameras 300 may include a first location first camera 200, a first location second camera 201, a first location second IP camera 201, a second location IP first camera 206, a second location IP second camera 207, and a second location IP third camera 208.

The image organizer 306 retrieves images from the cloud storage 305, organizes and moves them to the web server 307. The web server 307 owns a domain name that is used by viewers 303.

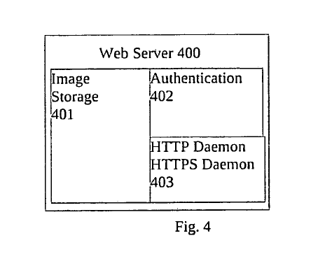

Viewers access the web server through the Internet connections 302 and search, playback the images. FIG. 4 shows the logical parts of the web server. The web server 400 is made of image storage 401, authentication 402, and http(s) daemon 403.

The image storage 401 is also a high capacity storage. It can be the same machine of the cloud storage 305 of the surveillance server. The authentication component 402 provides a password authentication for each IP camera's image data to avoid the illegal access. The http(s) daemon component 403 provides the interne access for viewers.

1. A surveillance system, comprising:
at least twenty IP cameras including a first location first camera, a first location second camera, a first location second IP camera, a second location IP first camera, a second location IP second camera, and a second location IP third camera;
a surveillance server located in the Internet cloud and storing the images from the at least twenty IP cameras and providing Internet access for at least three remote viewers at at least three remote viewer terminals, namely a first remote viewer at a first terminal, a second remote viewer at a second terminal and a third remote viewer at a third terminal.

2. The surveillance system of claim 1, wherein the cloud storage receives the images from cameras.

3. The surveillance system of claim 2, wherein the cloud storage owns at least one domain name used by remote IP cameras.

4. The surveillance system of claim 3, wherein the web server owns at least one domain name used by remote viewers.

5. The surveillance system of claim 1, wherein the web server provides functions of authentication, searching and playback for viewers.

6. The surveillance system of claim 5, wherein the cloud storage owns at least one domain name used by remote IP cameras.

7. The surveillance system of claim 6, wherein the web server owns at least one domain name used by remote viewers.

8. The surveillance system of claim 1, wherein the organizer retrieves the images from cloud storage, organizes and stores images to web server's storage.

9. The surveillance system of claim 8, wherein the cloud storage owns at least one domain name used by remote IP cameras.

10. The surveillance system of claim 9, wherein the web server owns at least one domain name used by remote viewers.
